(19) United States
(12) Patent Application Publication
(10) Pub. No.: US 2013/0166438 A1
(43) Pub. Date: Jun. 27, 2013

(54) TRANSACTION SERVICES TOOLS SYSTEM

(71) Applicants: Brian P. Theado, Canal Winchester, OH (US); Khoa N. Nguyen, Westerville, OH (US); Lloyd S. Palmer, JR., Hilliard, OH (US); Sean Kane, Jackson, MI (US); Manh Nguyen, Annandale, VA (US)

(72) Inventors: Brian P. Theado, Canal Winchester, OH (US); Khoa N. Nguyen, Westerville, OH (US); Lloyd S. Palmer, JR., Hilliard, OH (US); Sean Kane, Jackson, MI (US); Manh Nguyen, Annandale, VA (US)

(73) Assignee: VERIZON PATENT AND LICENSING INC., Basking Ridge, NJ (US)

(21) Appl. No.: 13/332,728

(22) Filed: Dec. 21, 2011

(51) Int. Cl. G06F 17/30; G06F 7/00; G06Q 40/00

(52) U.S. Cl. 705/39; 707/802; 707/705; 707/662; 707/E17.005; 707/E17.032

(57) ABSTRACT

One or more devices within a transaction services hub receive, from a first network device, provisioning information for customers of a transaction services network. The one or more devices also receive, from a second network device, first session data for transaction services using an Internet Protocol (IP) network, and receive, from a third network device, second session data for transaction services using a voice network. The one or more devices load, in a database, the provisioning information, the first session data, and the second session data, and merge, based on the provisioning information, the first session data and the second session data. The merged data is retrieved to support request from administrators and customers via other components of the transaction services hub.

### BACKGROUND

Transaction services may generally include data communications over a network to support a secure transaction. Transaction services may be characterized by short sessions to support inquiry-and-response applications. Transaction applications may include, for example, credit/debit card authorization, automated teller machine (ATM) activity, insurance verification, and home health monitoring. Customers of transaction services may include payment processing entities. Both customers and network administrators may benefit from a variety of data management and data collection tools to effectively facilitate transaction services.

### BRIEF DESCRIPTION OF THE DRAWINGS

FIG. 1 is a diagram that illustrates an exemplary network in which systems and/or methods, described herein, may be implemented;

FIG. 2 is a diagram that illustrates additional details of a portion of the network of FIG. 1;

FIG. 3 is a diagram that illustrates components of a transaction services hub of FIG. 2;

FIG. 4 is a diagram that illustrates an exemplary network arrangement for a portion of the transaction network of FIG. 1;

FIG. 5 is a diagram of exemplary components of a device that may be used within the network of FIGS. 1-4;

FIG. 6 is a diagram of exemplary communications for a portion of the network of FIG. 2;

FIG. 7 is a block diagram of exemplary functional components of the transaction services tools system of FIG. 3;

FIG. 8 is a block diagram of exemplary collector applications of FIG. 7;

FIG. 9 is a block diagram of exemplary usage data applications of FIG. 8;

FIG. 10 is a block diagram of exemplary tools applications of FIG. 7;

FIG. 11 is a block diagram of exemplary feed processing applications of FIG. 10;

FIG. 12 is a block diagram of exemplary network health reports of FIG. 10; and

FIG. 13 is a flowchart of an exemplary process for providing transaction services tools, according to an implementation described herein.

### DETAILED DESCRIPTION OF PREFERRED EMBODIMENTS

The following detailed description refers to the accompanying drawings. The same reference numbers in different drawings may identify the same or similar elements.

Transaction services may be provided to entities that need a network solution for short (e.g., typically less than 15 seconds) connections for their customers (e.g., merchants) to reach their hosts. A majority of traffic in transaction services can arise from credit or debit card transactions; but other types of traffic may also utilize these services, including insurance verification, home health monitoring, processing of fishing and hunting licenses, etc. Transaction services customers are typically referred to as “processors” or “hosts” that act as middle men between, for example, merchants on one end and banks or card marketing organizations (e.g., Visa®, Mastercard®, etc.) on the other end.

Systems and/or methods described herein may include one or more devices within a transaction services hub to manage interfaces to supporting external systems, such as billing, provisioning, monitoring, customer notification, etc. The systems and/or methods may include a database and various tools to manage and maintain other components of the transaction services hub. In one implementation, devices within a transaction services hub may receive, from a first network device, provisioning information for customers of a transaction services network. The devices may also receive, from a second network device, first session data for transaction services using an Internet Protocol (IP) network, and may receive, from a third network device, second session data for transaction services using a voice network. The devices may load, in a database, the provisioning information, the first session data, and the second session data, and may merge, based on the provisioning information, the first session data and the second session data. The merged data may be retrieved to support request from administrators and customers via other components of the transaction services hub.

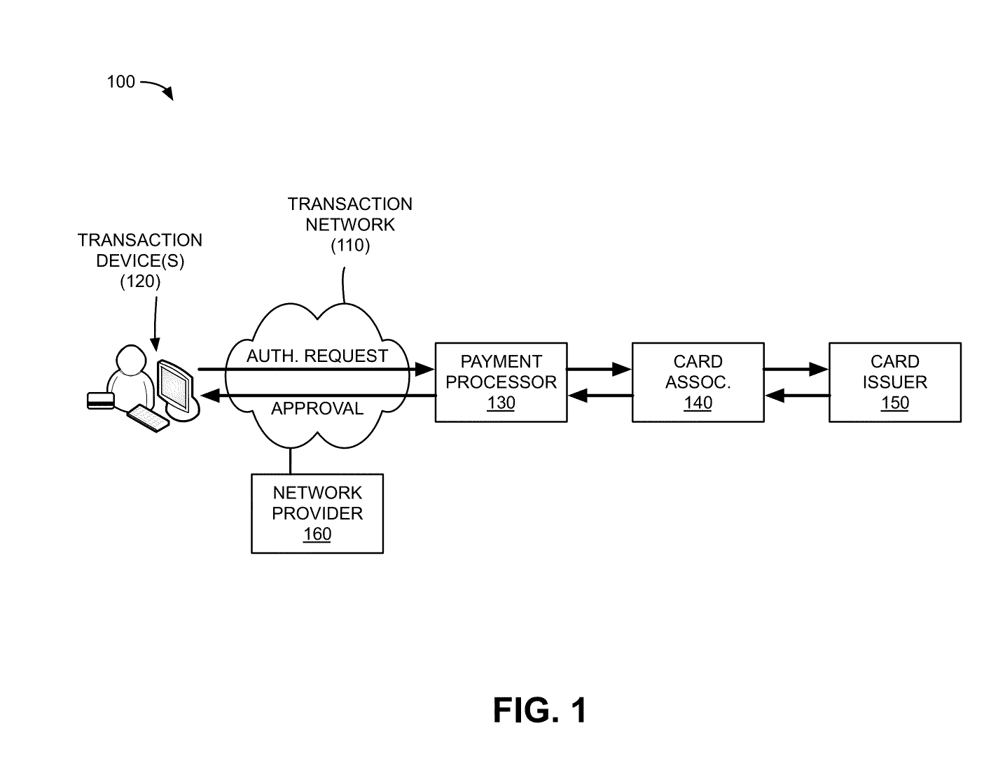

FIG. 1 is a diagram that illustrates an exemplary network 100 in which systems and/or methods described herein may be implemented. As shown in FIG. 1, network 100 may include a transaction network 110, a transaction device 120, a payment processor 130, a card association 140, a card issuer 150, and a network provider 160. Devices and/or networks of FIG. 1 may be connected via wired and/or wireless connections.

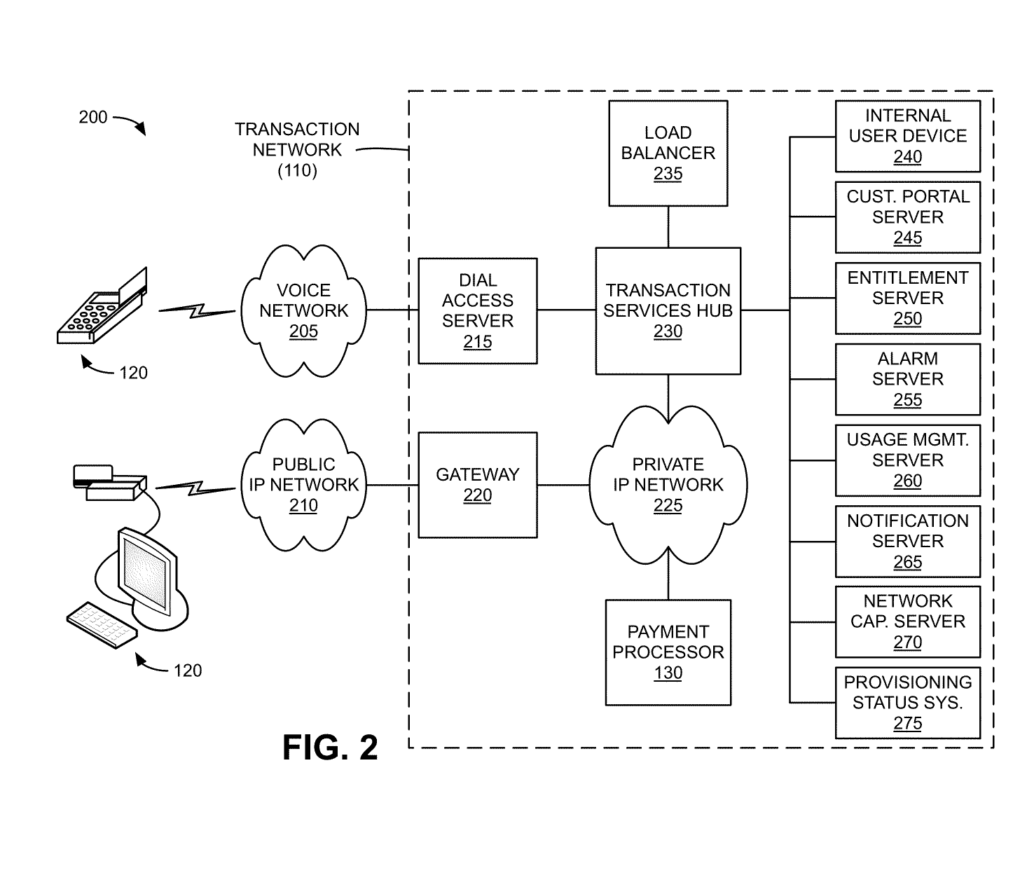

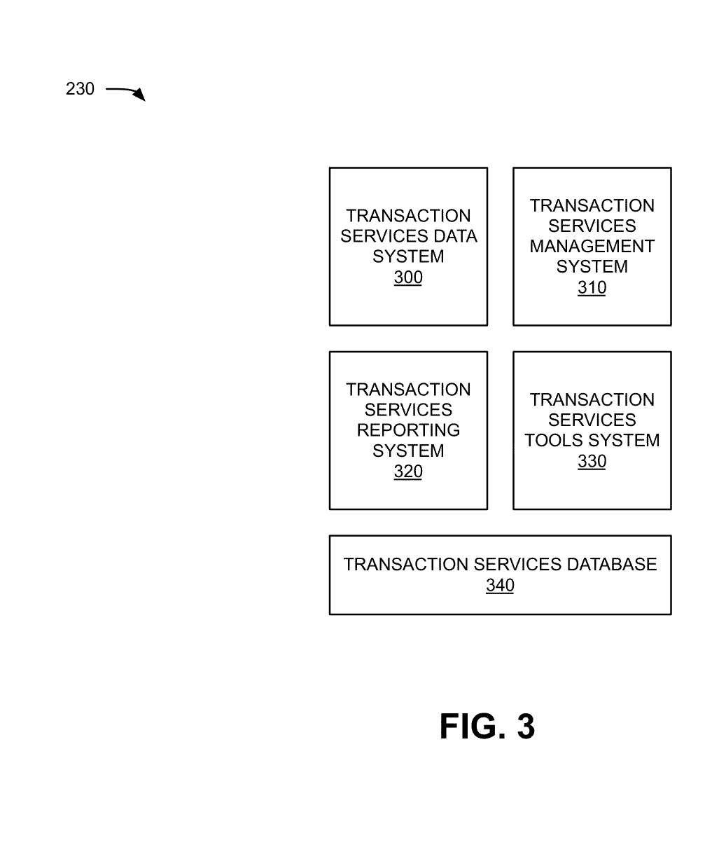

Transaction network 110 may include a network to facilitate data communications, such as credit card authorizations, between transaction device 120 and payment processor 130. Particularly, transaction network 110 may facilitate transactions characterized by short sessions, low bandwidth requirements, and quick call set-ups, for inquiry-response applications. Transaction network 110 may generally include one or more wired, wireless, and/or optical networks that are capable of receiving and transmitting data, voice and/or video signals. For example, transaction network 110 may include one or more public switched telephone networks (PSTNs) or another type of switched network. Transaction network 110 may also include one or more wireless networks and may include a number of transmission towers for receiving wireless signals and forwarding the wireless signals toward the intended destination. Transaction network 110 may further include one or more satellite networks, one or more packet switched networks, such as an Internet protocol (IP) based network, a local area network (LAN), a wide area network (WAN), a personal area network (PAN), a WiFi network, a Bluetooth network, an intranet, the Internet, or another type of network that is capable of transmitting data. In some implementations, transaction network 110 may include a private network controlled by, for example, a telecommunications company (e.g., network provider 160) that provides telephone and/or data access to transaction device 120. In another implementation, transaction network 110 may include a public network, such as the Internet, or a combination of public and private networks. Transaction network 110 is described further in connection with, for example, FIGS. 2 and 3.

Transaction device(s) 120 may include one or more computing devices and/or servers that participate in a transaction, such as a purchase of goods or services from a merchant or other entity associated with transaction device 120. For example, transaction device 120 may include an electronic cash register or point-of-sale system at a retail location or another device/system that is able to receive payment information and/or other information from a user and/or a payment card (e.g., credit card, identity card, etc.). Additionally, or alternatively, transaction device may include a personal computer, a laptop computer, a tablet or “pad” computer, a personal communications system (PCS) terminal (e.g., that may combine a cellular radiotelephone with data processing and data communications capabilities), a personal digital assistant (PDA, e.g., that can include a radiotelephone, a pager, Internet/intranet access, etc.), a smartphone, or other types of computation and/or communication devices. In one implementation, transaction device 120 may include any device (e.g., an IP-based device) that enables a user to access the Internet and/or communicate with other devices. In one implementation, transaction device 120 may communicate with payment processor 130 via transaction network 110 when a transaction (e.g., a credit card purchase, point-of-sale transaction, etc.) is taking place.

Payment processor 130 may include one or more server devices, or other types of computation or communication devices, that gather, process, search, and/or provide information in a manner described herein. Payment processor 130 (also referred to as a “host”) may route an authorization request from transaction device 120 to a particular card association 140. Payment processor 130 may be included, for example, within a customer's private network. In one implementation, payment processor 130 may receive, via transaction network 110, an inquiry (e.g., an authorization request) from transaction device 120 and provide a response (e.g., an approve/decline decision from card issuer 150) to transaction device 120 to facilitate a data transaction.

Card association 140 may include one or more server devices, or other types of computation or communication devices. Card association 140 may include, for example, an entity formed to administer and promote credit cards (e.g., Visa, Master Card, etc.).

Card issuer 150 may include one or more server devices, or other types of computation or communication devices. Card issuer 150 may include, for example, a bank or other institution that authorizes a transaction (e.g., verifies that sufficient funds are associated with a credit card, verifies access rights, etc.). In one implementation, card issuer 150 may receive an authorization request that originates from transaction device 120 and provide a response and/or authorization code to approve a transaction.

Network provider 160 may include an entity that provides and manages all or a portion of transaction network 110. Network provider 160 may receive fees (e.g., a per-transaction fee, flat fee, etc.) for providing transaction services via transaction network 110.

According to an implementation described herein, a merchant may utilize transaction device 120 to initiate transaction services (e.g., a credit card authorization request), via transaction network 110, originating using either a dial (e.g., voice network) or non-dial (e.g., Internet) connection. Regardless of the originating connection from transaction device 120, transaction network 110 may provide a single interface to payment processor 130. As described further herein, transaction network 110 may provide secure connections with management and reporting tools for customers (e.g., payment processor 130) of transaction network 110.

The exemplary configuration illustrated in FIG. 1 is provided for simplicity. It should be understood that a typical network may include more or fewer devices than illustrated in FIG. 1. For example, network 100, may include thousands of transaction devices 120 via which transactions may be made. In addition, network 100 may include additional elements, such as switches, gateways, routers, etc., that aid in routing data. Also, various functions are described below as being performed by particular components in network 100. In other implementations, various functions described as being performed by one device may be performed by another device or multiple other devices, and/or various functions described as being performed by multiple devices may be combined and performed by a single device.

FIG. 2 provides a diagram of a portion 200 of network 100. As shown in FIG. 2, network portion 200 may include transaction devices 120, payment processor 130, a voice network 205, a public IP network 210, a dial access server 215, a gateway 220, a private IP network 225, a transaction services hub 230, a load balancer 235, an internal user device 240, a customer portal server 245, an entitlement server 250, an alarm server 255, a usage management server 260, a notification server 265, a network capacity server 270, and a provisioning status system 275. Transaction devices 120 and payment processor 130 may include features described above in connection with FIG. 1.

Voice network 205 may include components that facilitate transfer of voice traffic and/or data traffic. For example, voice network 205 may include a PSTN, a domestic toll-free voice network, and/or an international toll-free voice network.

Public IP network 210 may include a wide area network, an intranet, or a combination of networks that support IP communications. Public IP network 210 may include, for example, an untrusted network, such as the Internet. Public IP network 210 may further include transport and/or network devices such as routers, switches, and/or firewalls.

Dial access server 215 may include one or more server devices, or other types of computation or communication devices. In one implementation, dial access server 215 may receive circuit-based signals and demodulate voice-band data of the circuit-based signals. The dial access server 215 may then extract IP packets for routing (e.g., via a TCP connection) to the appropriate destination, such as transaction services hub 230.

Gateway 220 may include one or more data transfer devices (or network devices), such as a gateway, a router, a switch, a firewall, a network interface card (NIC), a hub, a bridge, a proxy server, an optical add-drop multiplexer (OADM), or some other type of device that provides an interface between different networks. In one implementation, gateway 220 may include a hyper-text transfer protocol (HTTP) gateway or a secure socket layer (SSL) gateway to act as intermediary between public IP network 210 and private IP network 225.

Private IP network 225 may include devices and/or systems for providing services, such as a service for data transfers, voicemail, call blocking, calling card, audio, and/or network conferencing, etc. In some implementations, private IP network 225 may provide redundancy and/or the ability to distribute network loads. For example, private IP network 225 may include an IP network or a multiprotocol label switching (MPLS) network implementing an Interior Gateway Protocol (IGP) or another protocol that implements a minimum cost end-to-end path for routing between nodes. Private IP network 225 may provide one or more interface options to payment processor 130 (e.g., residing on a local customer network).

Transaction services hub 230 may include one or more server devices, or other types of computation or communication devices. Transaction services hub 230 may manage transactions from transaction device 120 via voice network 205 and/or from transaction device 120 via public IP network 210 (via gateway 220 and private IP network 225). Transaction services hub 230 may establish/maintain connectivity (e.g., secure TCP/IP sessions) with multiple payment processors 130, may route particular transaction authorization requests from a transaction device 120 to the appropriate payment processor, and may return responses (e.g., from payment processor 130) to the originating transaction device 120. For example, transaction services hub 230 may maintain a persistent socket connection (e.g., multiplexing user sessions over a single TCP session) to payment processor 130, non-persistent socket connections; multiple interfaces to multiple payment processors (e.g., with load balancing and/or failover services), support proprietary host protocols, TCP/IP interfaces, X.25 interfaces, etc. Transaction services hub 230 may also collect data regarding the transactions and provide an interface to retrieve reports based on the collected data.

Load balancer 235 may include one or more server devices, or other types of computation or communication devices. Load balancer 235 may receive transaction services requests and load balance the requests over devices in transaction services hub. For example, load balancer 235 may forward a received transaction services request to a device within transaction services hub 230 based on available resources (e.., processing time), geography, etc. For example, in one implementation, transaction services hub may include multiple redundant components (e.g., with geographic diversity) to enable seamless failover if a particular connection between payment processor 130 and transaction services hub 230 fails.

Generally, internal user device 240, customer portal server 245, entitlement server 250, alarm server 255, usage management server 260, notification server 265, network capacity server 270 and provisioning status system 275 may provide various interfaces to transaction services hub 230. In one implementation, each of internal user devices 240, customer portal server 245, entitlement server 250, alarm server 255, usage management server 260, notification server 265, network capacity server 270, and provisioning status system 275 may be integrated with other systems/services provided by network provider 160. For example, one or more of user device 240, customer portal server 245, entitlement server 250, alarm server 255, usage management server 260, notification server 265, network capacity server 270, and provisioning status system 275, and may provide access to information from multiple services (e.g., wireless services, Internet services, telephone services, etc.) besides transaction services.

User device 240 may include one or more computing devices, servers, or other types of computation or communication devices, that provide secure internal access to transaction services hub 230. User device 240 may, for example, allow users (e.g., a network administrator) to communicate with components of transaction services hub 230 via private secure connections. Users may use user device 240 to submit configuration settings, service level agreement (SLA) information, provisioning, etc. related to a particular payment processor 130.

Customer portal server 245 may include one or more network devices, or other types of computation or communication devices, that provide limited external access to transaction services hub 230. For example, customer portal server 245 may enable an authorized customer to access reporting data, residing in transaction services hub 230, that relates to a particular host (e.g., payment processor 130). In one implementation, customer portal server 245 may provide a common web-based interface to access multiple types of services (e.g., transaction services and other services). Access to services via customer portal server 245 may be restricted for example to users with registered accounts and secure passwords.

Entitlement server 250 may include one or more network devices, or other types of computation or communication devices that control what users (or user accounts) are permitted to access particular services. For example, entitlement server 250 may provide to transaction services hub 230 a file or list of user accounts that are authorized to access particular components of transaction services hub 230 (e.g., via internal user device 240 or customer portal server 245). In one implementation, entitlement server 250 may receive lists of authorized internal and/or external users from another device, such as a device associated with a subscription/account system.

Alarm server 255 may include one or more network devices, or other types of computation or communication devices that track and disperse alarm information relating to transaction services hub 230. For example, if transaction services hub 230 identifies a problem (e.g., a failed link with a payment processor 130), transaction services hub 230 may signal alarm server 255 to generate alarms to appropriate monitoring systems and/or ticketing systems. In one implementation, alarm server 255 may also consolidate and/or correlate alarms from multiple services (e.g., wireless services, Internet services, and/or transaction services).

Usage management server 260 may include one or more network devices, or other types of computation or communication devices that track system usage by customers. For example, usage management server 260 may collect transaction statistics from transaction services hub 230 to generate customer invoices.

Notification server 265 may include one or more network devices, or other types of computation or communication devices that generate notifications (e.g., email, text messages, etc.) for customers and/or internal users. For example, notification server 265 may receive indications of service interruptions (e.g., scheduled maintenance, outages, etc.) and automatically send notifications to particular customer accounts.

Network capacity server 270 may include one or more network devices, or other types of computation or communication devices that assign and track telephone numbers (e.g., tool-free dial numbers) with particular customers.

Provisioning status system 275 may include one or more network devices, or other types of computation or communication devices that track availability of network and/or system resources to support transaction services for particular customers. For example, provisioning status system 275 may track installation of new services, bandwidth availability, ports, paths and/or other information required to support service level agreements with customers.

Although FIG. 2 shows exemplary components of network portion 200, in other implementations, network portion 200 may include fewer, different, differently-arranged, or additional components than those depicted in FIG. 2. Alternatively, or additionally, one or more components of network portion 200 may perform one or more other tasks described as being performed by one or more other components of network portion 200.

FIG. 3 is a diagram that illustrates components of transaction services hub 230. As shown in FIG. 3, transaction services hub 230 may include a transaction services data system 300, a transaction services management system 310, a transaction services reporting system 320, a transaction services tools system 330, and a transaction services database 340.

Transaction services data system 300 may include one or more network devices, or other types of computation or communication devices. Transaction services data system 300 may generally be the primary component of transaction services hub 230 for processing customer transactions. Transaction services data system 300 may manage and/or monitor customer traffic (e.g., traffic relating to transaction services). Transaction services data system 300 may communicate with other components of transaction services hub 230 (e.g., transaction services management system 310, transaction services reporting system 320, etc.) to receive configuration settings and provide transaction statistics. For example, transaction services data system 300 may log information (e.g., origination source, time, etc.) about voice network transaction requests (e.g., via voice network 205) and/or an IP network transaction requests (e.g., via 210) and send the logged information to transaction services tools system 330 and/or transaction services tools database 340. In one implementation, transaction services data system 300 may collect logged information into various data files and push them to the transaction services tools system 330. Logged information may include usage detail records; session detail records; application status records; alarm detail files; and/or log files, crash dumps, or core files from transaction services data system 300 applications. Transaction services data system 300 may also monitor the health status of customer hosts (e.g., each payment processor 130) and gather data related to each processed transaction.

In one implementation, transaction services data system 300 may include instances of a transaction gateway application for each customer (e.g., one or more instances for each payment processor 130). The transaction gateway application may be the primary driver for processing customer connections. For example, transaction services data system 300 may receive an authorization request from transaction device 120 to initiate a transaction, may route the authorization request to an appropriate payment processor 130, and may return a response (e.g., approve/reject) from payment processor 130 to transaction device 120. The transaction gateway application may also apply/strip headers for packets, identify frame start/stops, and route communications based on active monitoring/capacities. In one implementation, transaction services data system 300 may be included as a blade system. Transaction services data system 300 may also be configured as a fully redundant system with no single point of failure.

Transaction services management system 310 may include one or more network devices, or other types of computation or communication devices. In one implementation, transaction services management system 310 may provide an internal portal (e.g., a Web-based system for internal users of network provider 160) for service delivery, operations, and marketing related to transaction services provided by transaction services hub 230. For example, transaction services management system 310 may provide for customer provisioning, configuration management, reporting, troubleshooting, and/or SLA management and publishing.

Transaction services reporting system 320 may include one or more network devices, or other types of computation or communication devices. Transaction services reporting system 320 may provide to customers (e.g., users associated with payment processor 130) reporting and/or administrative tools for transaction services provided by transaction network 110. In one implementation, customers may access transaction services reporting system 320 via a customer portal (e.g., a Web-based system for external users of network provider 160). For example, customer portal server 245 may provide a gateway to transaction services reporting system 320. Transaction services reporting system 320 may provide customers with a variety of reporting formats/data and may give customers the ability to manage traffic to particular hosts using, for example, a Web-based interface.

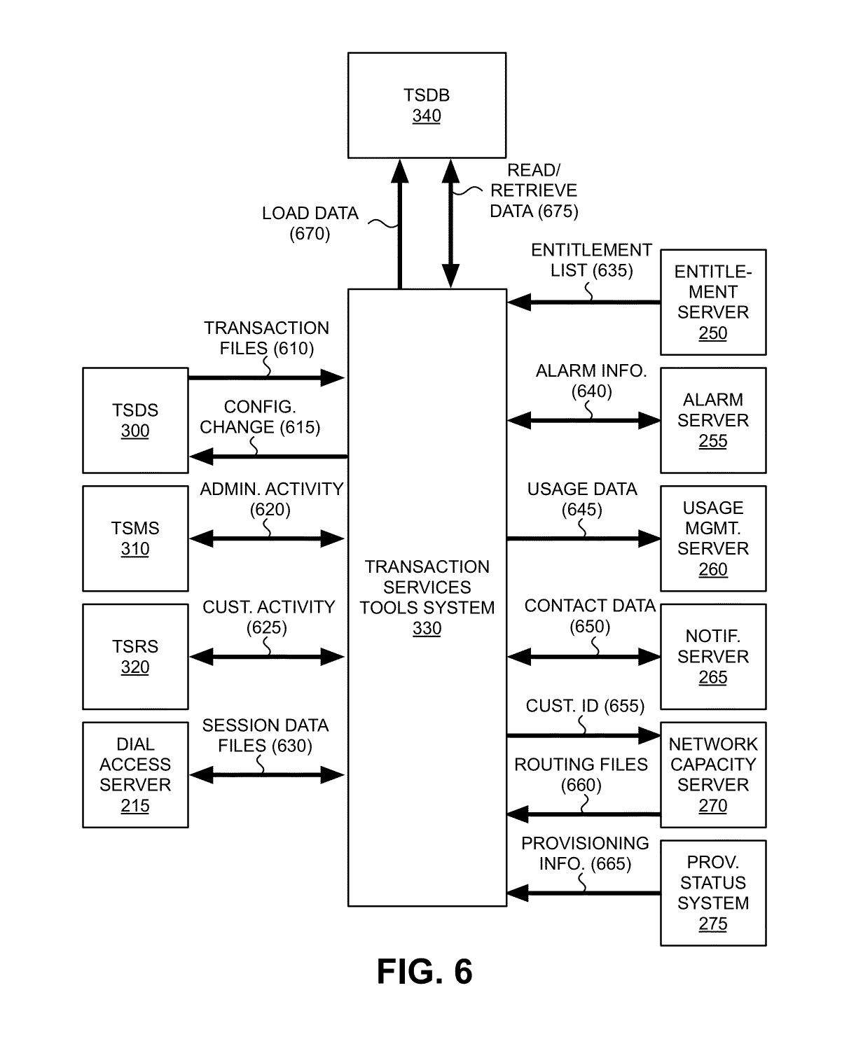

Transaction services tools system 330 may include one or more network devices, or other types of computation or communication devices. Transaction services tools system 330 may include collector applications and tools applications. The collector applications generally may receive and format data for storage. The tool applications generally may provide a variety of applications to manipulate, process, and/or control reporting of stored data. In one implementation, transaction services tools system 330 may provide interfaces to billing, provisioning, monitoring, customer notification, and enterprise support systems. Transaction services tools system 330 may also include various tools to manage and maintain the other components. In one implementation, transaction services tools system 330 may also communicate with a backend database (e.g., transaction services database 340) to format and store statistics of processed transactions. Transaction services tools system 330 is described further in connection with, for example, FIGS. 6-13.

Transaction services database 340 may store transaction information collected and/or generated by one or more of transaction services data system 300, transaction services management system 310, transaction services reporting system 320, and transaction services tools system 330. In one implementation, stored information in transaction services database 340 may be retrieved directly by one of transaction services data system 300, transaction services management system 310, transaction services reporting system 320, or transaction services tools system 330. In another implementation, transaction services tools system 330 may process data retrieval requests from the other transaction services hub 230 components. In one implementation, transaction services database 340 may include stored procedures (e.g., subprograms, such as Oracle® Stored Procedures, etc.) to manipulate data. For example, access to transaction services database 340 from transaction services tool system 330 (e.g., based on a user request via transaction services reporting system 320) may be completed using calls to stored procedures to prevent common security breaches, such as SQL injection, etc. Thus, components of transaction services hub 230 may access transaction services database 340 using calls to the stored procedures.

Although FIG. 3 shows exemplary components of transaction services hub 230, in other implementations, transaction services hub 230 may include fewer, different, differently-arranged, or additional components than depicted in FIG. 3. Alternatively, or additionally, one or more components of transaction services hub 230 may perform one or more other tasks described as being performed by one or more other components of transaction services hub 230.

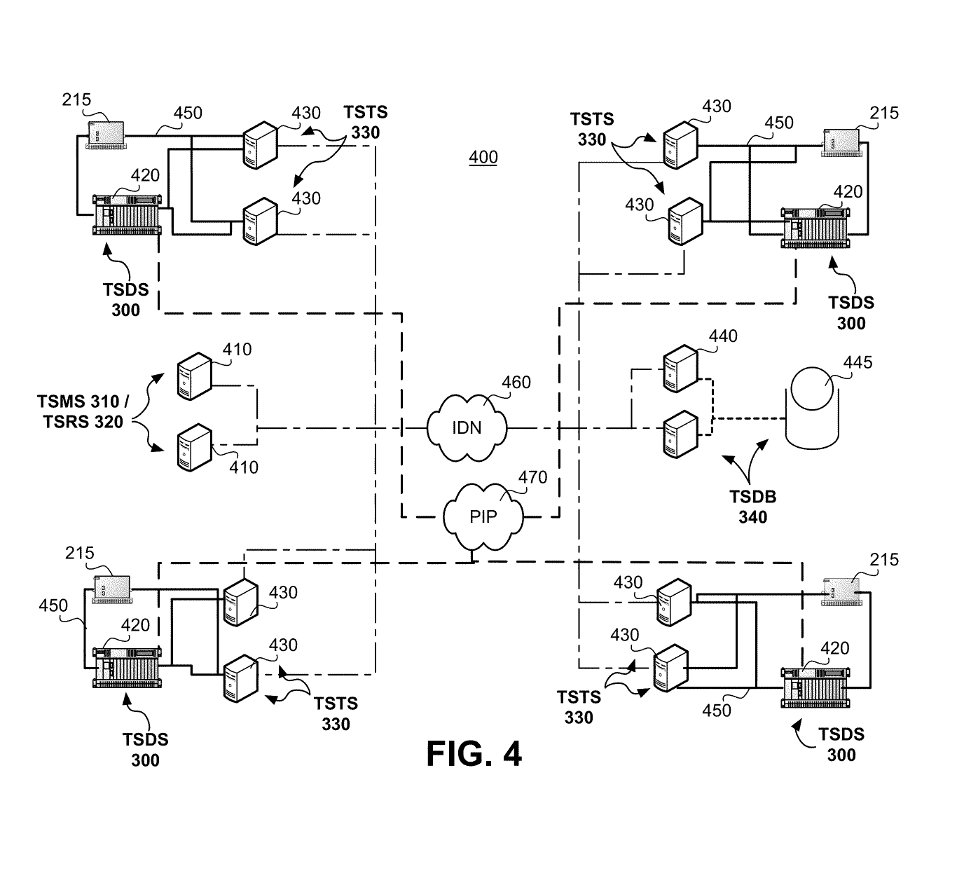

Functional components of transaction services hub 230 (e.g., transaction services data system 300, transaction services management system 310, transaction services reporting system 320, transaction services tools system 330, and transaction services database 340) may be arranged in a distributed and/or redundant network configuration. FIG. 4 provides an exemplary network arrangement for a portion 400 of transaction network 110 that may include a distributed configuration for transaction services hub 230. A shown in FIG. 4, network portion 400 may include web servers 410, blade servers 420, tools servers 430, and database servers 440 interconnected by one or more of a LAN connection 450, an internal data network (IDN) connection 460, or a private IP (PIP) network connection 470.

Web servers 410 may perform functions of transaction services management system 310 and/or transaction services reporting system 320. User/customer access (not shown) to web servers 410 may be restricted by network accounts and/or a type of network connectivity. Web servers 410 may communicate with tools servers 430 and/or database servers 440 via IDN connections 460.

Blade servers 420 may each execute a transaction gateway application and other applications to perform functions of transaction services data system 300. There may be multiple instances of blade servers 420 (e.g., providing a primary and a backup role) at each distributed location of transaction services hub 230. Blade servers 420 may communicate with their respective local tools servers 430 and dial access servers 215 via LAN connections 450. For example, by default, blade servers 420 may push data files to tools servers 430 that are at the same location as blade server(s) 420. In another implementation, blade servers 420 may failover and forward data files to tools servers 430 at other locations (e.g., via PIP network connections 470). Blade servers 420 may communicate with other remote blade servers 420 via PIP network connections 470.

Tools servers 430 may execute applications described herein to perform functions of transaction services tools system 330. As shown in FIG. 4, there may multiple instances of tools servers 430 (e.g., providing a primary and a backup role) at each distributed location of transaction services hub 230. Tools servers 430 may communicate locally with each other, local blade servers 420, and local dial access server 215 via LAN connections 450. Tools severs 430 may communicate with remote tools servers 430, web servers 410, and/or database servers 440 via IDN connections 460.

Database servers 440 may execute applications to perform functions of transaction services database 340. Database servers 440 may communicate with web servers 410 and/or tools servers 430 via IDN connections 460. Database servers 440 may also include local connections to one or more databases.

Although FIG. 4 shows exemplary components of network portion 400, in other implementations, network portion 400 may include fewer, different, differently-arranged, or additional components than the ones depicted in FIG. 4. Alternatively, or additionally, one or more components of network portion 400 may perform one or more other tasks described as being performed by one or more other components of network portion 400.

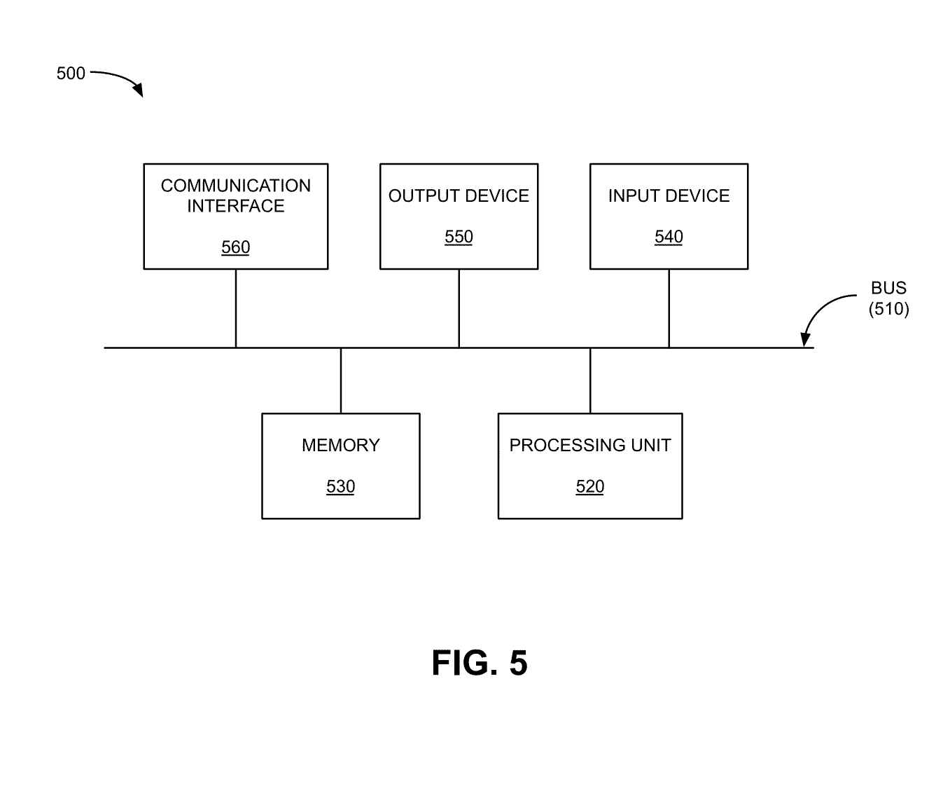

FIG. 5 is a diagram of exemplary components of a device 500. Device 500 may correspond to transaction device 120, payment processor 130, dial access server 215, gateway 220, load balancer 235, user device 240, customer portal server 245, entitlement server 250, alarm server 255, usage management server 260, notification server 265, network capacity server 270, provisioning status system 275, transaction services data system 300, transaction services management system 310, transaction services reporting system 320, transaction services tools system 330, transaction services database 340, web server 410, blade server 420, tools server 430, or database server 440. Each of transaction device 120, payment processor 130, dial access server 215, gateway 220, load balancer 235, user device 240, customer portal server 245, entitlement server 250, alarm server 255, usage management server 260, notification server 265, network capacity server 270, provisioning status system 275, transaction services data system 300, transaction services management system 310, transaction services reporting system 320, transaction services tools system 330, transaction services database 340, web server 410, blade server 420, tools server 430, and database server 440 may include one or more devices 500. As shown in FIG. 5, device 500 may include a bus 510, a processing unit 520, a memory 530, an input device 540, an output device 550, and a communication interface 560.

Bus 510 may permit communication among the components of device 500. Processing unit 520 may include one or more processors or microprocessors that interpret and execute instructions. In other implementations, processing unit 520 may be implemented as or include one or more application specific integrated circuits (ASICs), field programmable gate arrays (FPGAs), or the like.

Memory 530 may include a random access memory (RAM) or another type of dynamic storage device that stores information and instructions for execution by processing unit 520, a read only memory (ROM) or another type of static storage device that stores static information and instructions for execution by processing unit 520, and/or some other type of magnetic or optical recording medium and its corresponding drive for storing information and/or instructions.

Input device 540 may include a device that permits an operator to input information to device 500, such as a keyboard, a keypad, a mouse, a pen, a microphone, one or more biometric mechanisms, or the like. Output device 550 may include a device that outputs information to the operator, such as a display, a speaker, etc.

Communication interface 560 may include a transceiver (e.g., a transmitter and/or receiver) that enables device 500 to communicate with other devices and/or systems. For example, communication interface 560 may include mechanisms for communicating with other devices, such as other devices of network 100 or another device 500.

As described herein, device 500 may perform certain operations in response to processing unit 520 executing software instructions contained in a computer-readable medium, such as memory 530. A computer-readable medium may include a non-transitory memory device. A memory device may include space within a single physical memory device or spread across multiple physical memory devices. The software instructions may be read into memory 530 from another computer-readable medium or from another device via communication interface 560. The software instructions contained in memory 530 may cause processing unit 520 to perform processes described herein. Alternatively, hardwired circuitry may be used in place of or in combination with software instructions to implement processes described herein. Thus, implementations described herein are not limited to any specific combination of hardware circuitry and software.

Although FIG. 5 shows exemplary components of device 500, in other implementations, device 500 may include fewer components, different components, differently arranged components, or additional components than depicted in FIG. 5. As an example, in some implementations, input device 540 and/or output device 550 may not be implemented by device 500. In these situations, device 500 may be a “headless” device that does not explicitly include an input or an output device. Alternatively, or additionally, one or more components of device 500 may perform one or more other tasks described as being performed by one or more other components of device 500.

FIG. 6 is a diagram of exemplary communications for a portion 600 of network transaction network 110. As shown in FIG. 6, network portion 600 may include dial access server 215, entitlement server 250, alarm server 255, usage management server 260, notification server 265, network capacity server 270, provisioning status system 275, transaction services data system 300, transaction services management system 310, transaction services reporting system 320, transaction services tools system 330, and transaction services database 340. Communications shown in network portion 600 relate to transaction services tools system 330. Other communications within network portion 600 are not included for simplicity.

Transaction services tools system 330 may receive transaction files 610 from transaction services data system 300. Transaction files 610 may generally include information recorded from sessions between transaction devices 120 and payment processor 130. Transaction files 610 may include, for example, usage detail records; session detail records; application status records; alarm detail files; and/or log files, crash dumps, or core files from transaction services data system 300 applications.

Transaction services tools system 330 may also inform transaction services data system 300 of configuration changes 615 that may be initiated, for example, by users of transaction services management system 310. In one implementation, transaction services tools system 330 may notify transaction services data system 300 of a configuration change and transaction services data system 300 may implement the configuration change at the user's schedule maintenance time.

Transaction services tools system 330 and transaction services management system 310 may exchange information generally referred to in FIG. 6 as administrative activity 620. For example, transaction services management system 310 may provide to transaction services tools system 330 instructions, such as provisioning instructions, configuration information, routing information, bandwidth reservations, port information, etc. that is required to support data transfers to/from a particular customer (e.g., payment processor 130). Transaction services management system 310 may also request information, from transaction services tools system 330, such as reports or configuration information. As indicated by reference number 670, transaction services tools system 330 may retrieve data from transaction services database 340 responsive to such requests and forward the retrieved data as part of administrative activity 620.

Transaction services tools system 330 and transaction services reporting system 320 may exchange information generally referred to in FIG. 6 as customer activity 625. For example, transaction services tools system 330 may receive certain requests from transaction services reporting system 320. The requests may correspond to, for example, a report request that includes a user's selection from a menu of available report types. In one implementation, requests may also include configuration changes, ad hoc reporting configurations, and/or point-of-contact changes for a particular customer. As indicated by reference number 670, transaction services tools system 330 may retrieve data from transaction services database 340 and forward the retrieved data as part of customer activity 625.

Transaction services tools system 330 may maintain active TCP connections with dial access server 215 and may receive session data files 630 from dial access server(s) 215. Session data files 630 may include, for example, session detail records and/or accounting records for calls originating through voice network 205.

Transaction services tools system 330 may receive entitlement list 635 from entitlement server 250. Entitlement list 635 may contain a list of external/customer users that are allowed to access transaction services hub (e.g., transaction services reporting system 320). Transaction services tools system 330 may use entitlement list 635 to map users to their appropriate customer accounts.

Transaction services tools system 330 may send alarm information 640 to alarm server 255. For example, transaction services tools system 330 may monitor alarm tables and notify alarm server 255 of alarm conditions. Based on configurations (e.g., provided from alarm server 255 or customer activity 625), transaction services tools system 330 may also send emails to individual email accounts (not shown) to make sure that the appropriate support teams are notified in near real time for critical issues.

Transaction services tools system 330 may aggregate data from transaction files 610, session data files 630, and/or other data from transaction services database 340 and may provide the aggregated data to usage management server 260 as usage data 645. Usage data 645 may include, for example, customer-specific session billing data, billing audit information, and the like that may be used to generate customer invoices.

Transaction services tools system 330 may provide contact data 650 to notification server 265. In one implementation, contact data 650 may be extracted from, for example, administrator activity 615 and/or customer activity 625. Contact data 650 may include, for example, a customer point-of-contact list for reporting scheduled maintenance and/or unscheduled outages.

Transaction services tools system 330 may provide customer identifiers 655 to network capacity server 270. Network capacity server 270 may receive the customer identifiers to, for example, associate routing paths for transaction services with particular customers. Network capacity server 270 may also send routing files 660 to transaction services tools system 330. Routing files 635 may include information about specific toll free numbers and routing plans (e.g., associated with a particular payment processor 130).

Transaction services tools system 330 may receive provisioning information 665 from provisioning status system 275. Provisioning information 665 may include, for example, files that inform transaction services hub 230 when various customer orders are completed (e.g., provisioned to begin receiving transaction requests from transaction devices 120).

Transaction services tools system 330 may validate, unpack, and load files into appropriate tables for transaction services database 340, as indicated by reference 670. For example, transaction files 610, data from administrator activity 620, data from customer activity 625, session data files 630, entitlement list 635, alarm information 640, contact data 645, routing files 660, and/or provisioning information 665 may be forwarded as formatted data 610 to transaction services database 340 for storage. In one implementation, transaction services tools system 330 may also periodically place data and/or log files into compressed archives, as well as completely removing obsolete files.

Additionally, or alternatively, transaction services tools system 330 may periodically read and/or retrieve information from transaction services database 340, as indicated by reference number 675. For example, transaction services tools system 330 may retrieve data responsive to a request in administrator activity 620 or customer activity 625. As another example, transaction services tools system 330 may scan transaction services database 340 to identify updates (e.g., configuration updates, reporting updates, etc. provided by other components of transaction services hub 230). Transaction services tools system 330 may implement the updates and/or report the updates to other transaction services hub 230 components (e.g., transaction services data system 300, transaction services management system 310, and/or transaction services reporting system 320). Thus, transaction services tools system 330 may provide an intermediate communication interface to promote network/data security.

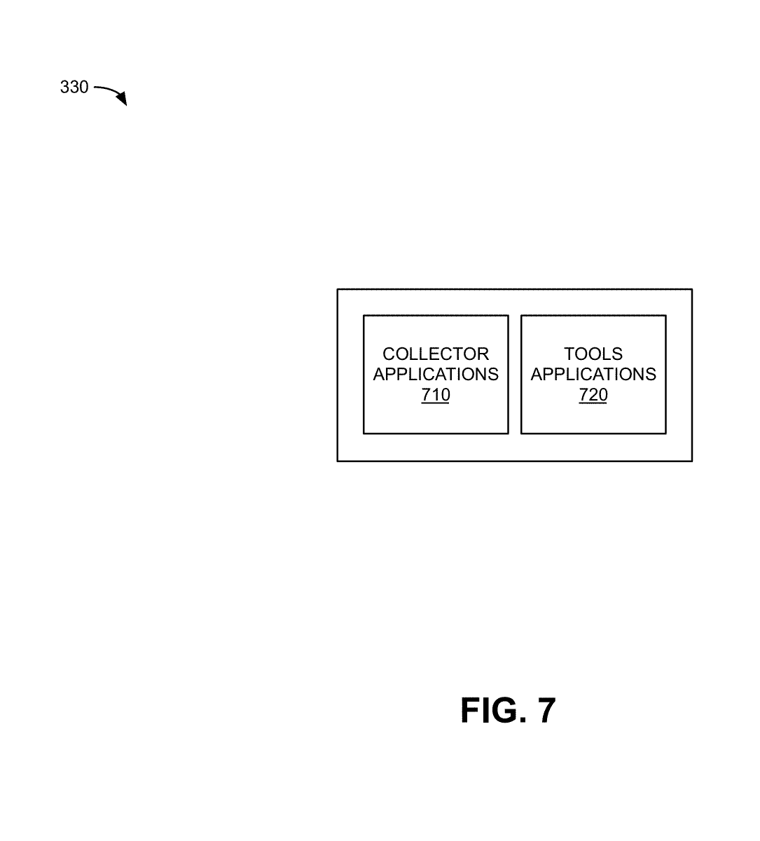

FIG. 7 is a block diagram of exemplary functional components of transaction services tools system 330. As shown, transaction services tools system 330 may include a collector applications module 710 and a tools applications module 720. Depending on the implementation, transaction services tools system 330 may include additional, fewer, or different functional components than those illustrated in FIG. 7.

Collector applications module 710 and a tools applications module 720 may include different groupings of applications. Applications that concurrently run on multiple remote tools servers 430 may be grouped with collector applications module 710. Applications that run on single server at a given time may be grouped with tools applications module 720.

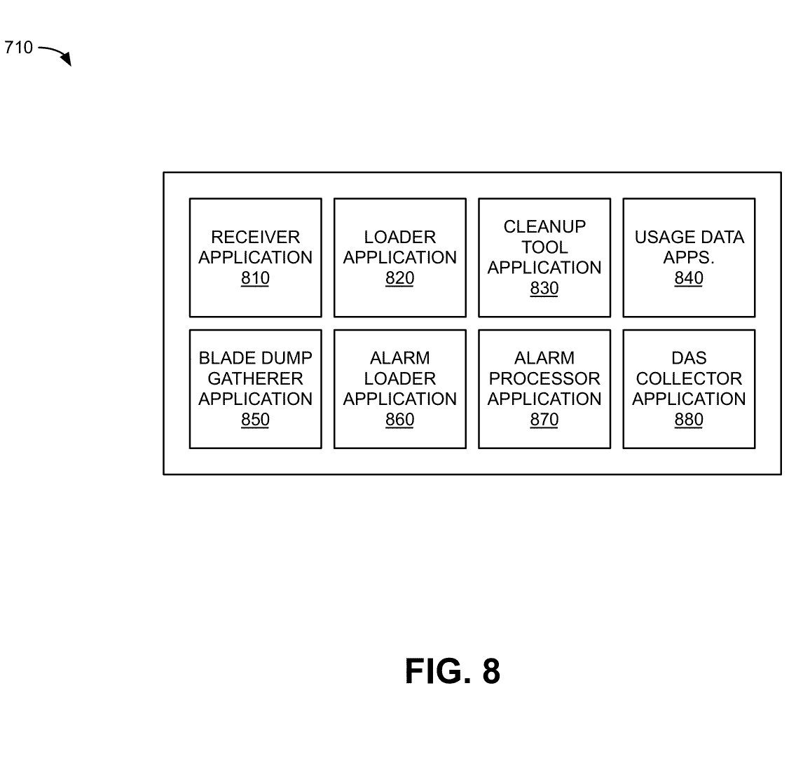

Applications in collector applications module 710 may include functional components included in FIG. 8. As shown in FIG. 8, collector applications module 710 may include, for example, a receiver application 810, a loader application 820, a cleanup tool application 830, usage data applications 840, a blade dump gatherer application 850, an alarm-loader application 860, an alarm processor application 870, and a dial-up access server (DAS) collector application 880.

Receiver application 810 may receive data files from transaction services data system 300 (e.g., logged information such as usage detail records, session detail records, application status records, alarm detail files, etc. that transaction services data system 300 ships to the transaction services tools system 330). Receiver application 810 may validate checksums provided by transaction services data system 300 and unpack the received files (e.g., if the files are compressed). In some instances, receiver application 810 may forward the unpacked files to loader application 820.

Loader application 820 may receive files from receiver application 810, as well as files produced by other tool and collector applications, and load the files into the appropriate tables in transaction services database 340.

Cleanup tool application 830 may manage collector applications module 710 and/or tools applications module 720. For example, cleanup tool application 830 may periodically place data and log files (e.g., files loaded by loader application 820) into compressed archives, as well as completely removing other files.

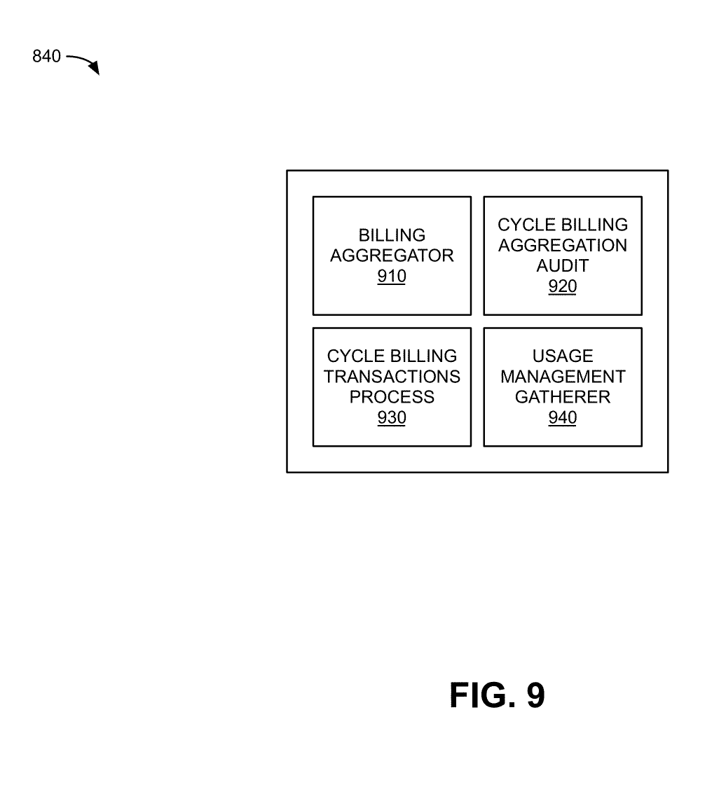

Usage data applications 840 may include a variety of collector applications to track usage statistics for transaction services hub 230. Usage data applications 840 may include functional components included in FIG. 9. As shown in FIG. 9, usage data applications 840 may include a billing aggregator 910, a cycle billing aggregation audit 920, a cycle billing transaction process 930, and a usage management (UM) gatherer 940.

Billing aggregator 910 may aggregate session billing data into customer-specific totals for invoice generating and/or billing systems. Cycle billing aggregation audit 920 may perform a periodic billing audit process for end-to-end verification of billing records at the invoice generating and/or billing systems. In one implementation, cycle billing aggregation audit 920 may not include audit information from transaction services data system 300.

Cycle billing transactions process 930 may perform a periodic billing audit process for end-to-end verification of billing records in transaction services hub 230. Usage management gatherer 940 may collect files produced by the other billing tools within transaction services tools system 330 and may push the files to a usage management application that may reside on, for example, usage management server 260. The usage management application may process data from transaction services hub 230 along with data from several other products/services. Data from usage management gatherer 940 may be processed by usage management server 260 and eventually sent to invoice generating and/or billing systems.

Returning to FIG. 8, blade dump gatherer application 850 may collect log files and/or crash dump files produced by transaction services data system 300 (e.g., blade server 420) and may load the files into transaction services database 340.

Alarm loader application 860 may receive alarm files from receiver application 810, as well as alarm files produced by other tool and collector applications, and may load the files into the appropriate tables in transaction services database 340. Alarm loader application 860 may, thus, function similarly to loader application 820, but exclusively for alarm files, to ensure that alarms receive priority handling.

Alarm processor application 870 may be responsible for monitoring the alarm tables (e.g., in transaction services database 340), and based on configuration, alarm processor application 870 can send emails or generate Simple Network Management Protocol (SNMP) traps to an alarm notification platform (e.g., alarm server 255), which in turn makes sure that the appropriate support teams are notified in near real time for critical issues. In one implementation, alarm processor application 870 may run on all tools servers 430 of transaction services tools system 330, but only one instance of alarm processor application 870 may serve as the active or primary alarm processor at any given time. The remaining instances of alarm processor application 870 may stay in a mostly idle mode waiting for issues that might cause the current primary alarm processor application 870 to relinquish control to one of the remaining instances.

Dial access server (DAS) collector application 880 may maintain active TCP connections with a Vendor-supplied dial access server (e.g., dial access server 215) and may collect session detail records and/or accounting records. Dial access server collector application 880 may create the appropriate files for loader application 820 to push this data into the appropriate table in transaction services database 340.

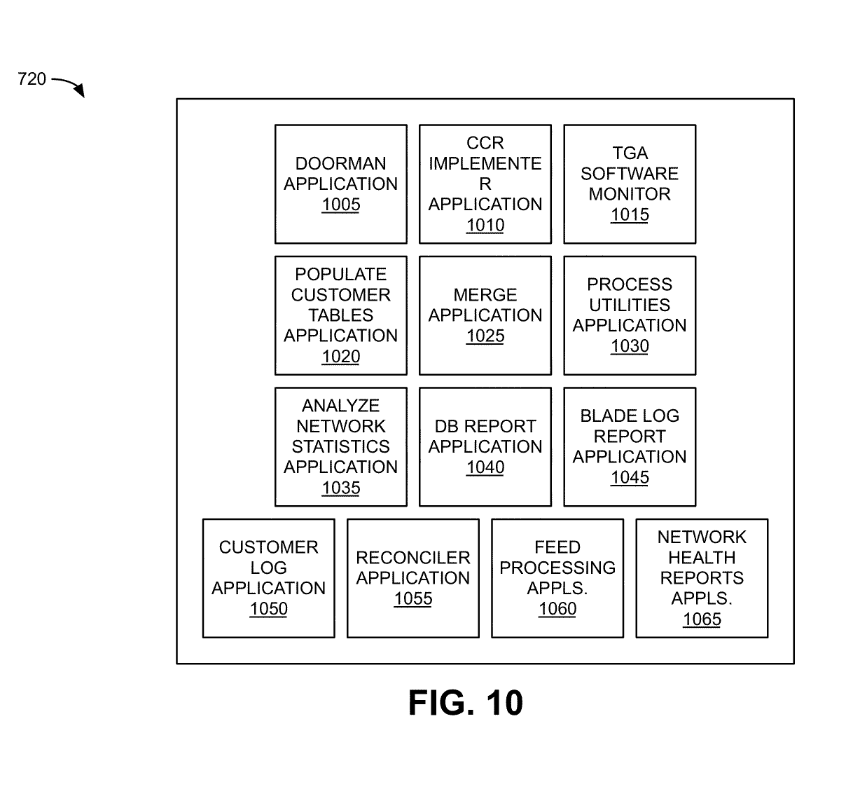

Returning to FIG. 7, applications in tools applications module 720 may include functional components included in FIG. 10. As shown in FIG. 10, tools applications module 720 may include, for example, a doorman application 1005, a configuration change request (CCR) implementer application 1010, a transaction services gateway (TGA) software monitor 1015, a populate customer tables application 1020, a process utilities application 1030, an analyze network statistics application 1035, a database (DB) report application 1040, a blade log report application 1045, a customer log application 1050, a reconciler application 1055, feed processing applications 1060, and network health report applications 1065.

Doorman application 1005 may monitor transaction services database 340 for customer requests (e.g., generated via transaction services reporting system 310) to administratively open and shut the destinations, and then may connect to appropriate transaction services data system 300 applications to tell them to stop or resume use of those destinations.

CCR implementer application 1010 may monitor the configuration transaction services database 340, and when requested, may implement changes that were requested by users (e.g., users of transaction services reporting system 310). In one implementation, CCR implementer application 1010 may make appropriate changes to configuration tables in transaction services database 340, as well as notifying each blade server 420 to initiate a configuration update for transaction services data system 300.

TGA software monitor 1015 may ensure other systems (e.g., transaction services management system 320) are aware of what executable versions of the transaction gateway applications, running on each blade server 420, are available for customers to use.

Populate customer tables application 1020 may update tables in transaction services database 340 that are used by transaction services management system 320. For example, populate customer tables application 1020 may updated tables for trend reporting applications.

Merge application 1025 may provide a utility to merge session detail records from dial access server 215 into session detail records produced by transaction gateway applications for transaction services data system 300.

Process utilities application 1030 may receive session detail records (e.g., from merge application 1025 and/or transaction services data system 300) and analyze the session detail records to determine traffic patterns. For example, process utilities application 1030 may determine peak traffic utilization according to several different breakdowns, such as for the overall network (e.g., transaction network 110), by customer, by customer destination, etc. In one implementation, process utilities application 1030 may populate various tables in transaction services database 340 for later use by reporting applications.

Analyze network statistics application 1035 may receive session detail records (e.g., from merge application 1025 and/or transaction services data system 300) and analyze the session detail records to detect usage problems. In one implementation, analyze network statistics application 1035 may look for significant drops in network utilization (overall or by access type). When a particular utilization threshold is met, analyze network statistics application 1035 may generate alarm files so that appropriate teams are notified in near real time. The thresholds used by analyze network statistics application 1035 can be configured, for example, via transaction services management system 320.

Database report application 1040 may allow for various reports to be scheduled and processed. Report options may include, for example, a transaction counts report, application detail reports, access detail reports, locale summary reports, locale detail reports, average time on the network (e.g., transaction network 110) reports, counts of time on the network summary reports, counts of time on the network detail reports, peak utilization reports, session details, SLA reports, access type reports, etc. In one implementation database report application 1040 may generate reports to for distribution via email. In another implementation, database report application 1040 may deliver report files using a secure file transfer program.

Blade log report application 1045 may analyze the log files generated by transaction services data system 300 and centrally stored by the blade dump gatherer application 850. In one implementation, blade log report application 1045 may identify errors that occurred and forward identified error messages (e.g., via email) to the appropriate network administration teams.

Customer log application 1050 may compress (e.g., zip) and/or rename customer log files (e.g., files generated by access audit logs on transaction services data system 300 for transfer to payment processor 130).

Reconciler application 1055 may perform an overall audit process that verifies the billing data produced by cycle billing transactions process 930 against audit information from transaction services data system 300.

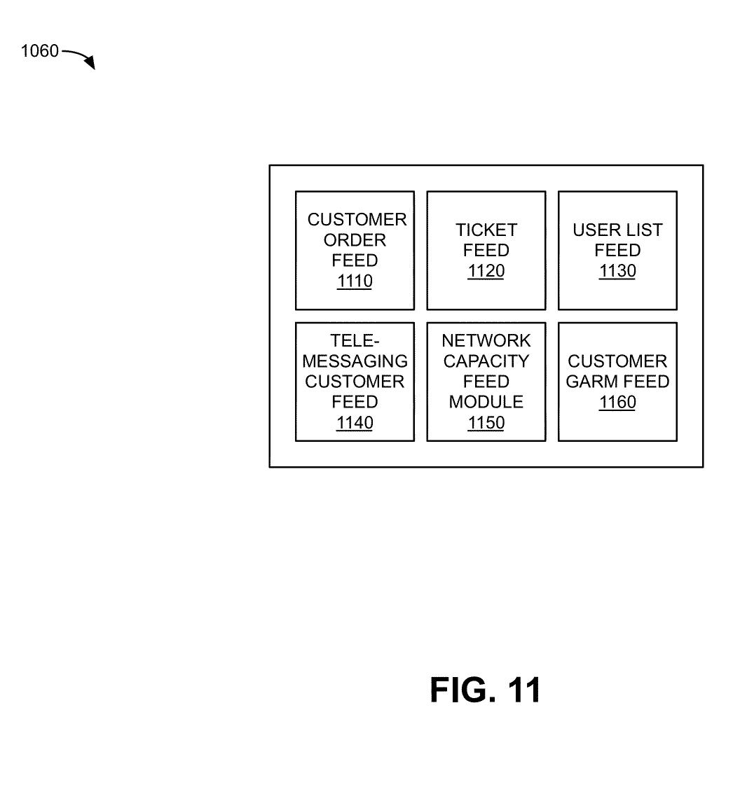

Feed processing applications 1060 may include the functional components shown in FIG. 11. As shown in FIG. 11, feed processing applications 1060 may include a customer order feed 1110, a ticket feed 1120, a user list feed 1130, a telemessaging customer feed 1140, a network capacity feed module 1150, and a customer global access rights management (GARM) feed 1160.

Customer order feed 1110 may accepts order files from a customer order processing application. The order files may inform transaction services hub 230 when various customer orders are completed and provide particular customer circuit information (e.g., access numbers, backup numbers, services level information, etc.). The customer circuit information may be stored for display to, for example, users of transaction services management system 320.

Ticket feed 1120 may retrieve a file (e.g., from a ticketing management system associated with alarm server 255) showing all transaction services related tickets (problem report tickets, maintenance tickets, etc.). Ticket report information may be used, for example, to respond to requests for SLA reports (e.g., generated via transaction services reporting system 310).

User list feed 1130 may include a list of external/customer users that are allowed to access transaction services reporting system 310. User list feed may be used, for example, to map users to the appropriate customer entity associated with the user.

Telemessaging customer feed 1140 may generate a feed to a telemessaging/answering service, giving it a list of customers associated with transaction services network 110. In one implementation, telemessaging customer feed 1140 may include a generator component and a gathering component. The gathering component may collect customer list files (e.g., from entitlement server 250) and may load the customer list files into transaction services database 340.

Network capacity feed module 1150 may send files to and/or receive files from a network capacity planning system (e.g., network capacity server 270 and/or provisioning status system 275). For example, network capacity feed module 1150 may send a file with a list of corporate identifiers used by customers of transaction network 110. Additionally, network capacity feed module 1150 may receive several files, from the network capture application, containing information about specific toll free numbers and routing plans for transaction services network 110. This information is in turned stored in transaction services database 340 for later display to, for example, users of transaction services management system 320.

Customer GARM feed 1160 may receive a file containing customer IDs and their associated GARM values (e.g., access rights). For example, customer GARM feed 1160 may receive a customer ID file from entitlement server 250. The file may be used by, for example, transaction services management system 320 to determine which internal users (e.g., network administrators) are allowed to see data from which customers. For example, if a customer is a particular government entity, some off-shore internal users may not be allowed to view that customer's data. The internal user's assigned GARM value may be obtained, for example, during a login sequence for transaction services management system 320.

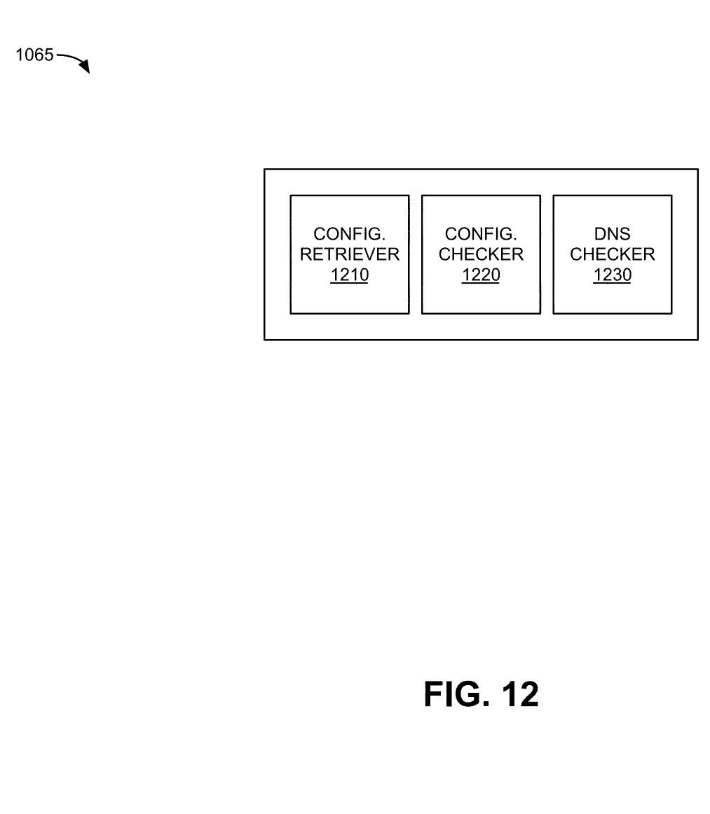

Returning to FIG. 10, network health reports application 1065 may include the functional components shown in FIG. 12. As shown in FIG. 12, network health reports 1065 may include a configuration retriever 1210, a configuration checker 1220, and a DNS checker 1230.

Configuration retriever 1210 may obtain files from network management servers (e.g., network capacity server 270, provisioning status system 275, etc.) that may be reviewed for issues. Files may include, for example, router configuration files and/or syslog files.

Configuration checker 1220 may parse the syslog files and router configuration files obtained by configuration retriever 1210. In one implementation, configuration checker 1220 may generate a daily report on the health of components of transaction services network 110.

DNS checker 1230 may monitor the URLs used by customers for SSL and HTTPS access to transaction services data system 300. In one implementation, DNS checker 1230 may generate emails (e.g., to network administrators) when particular URLs cannot be resolved.

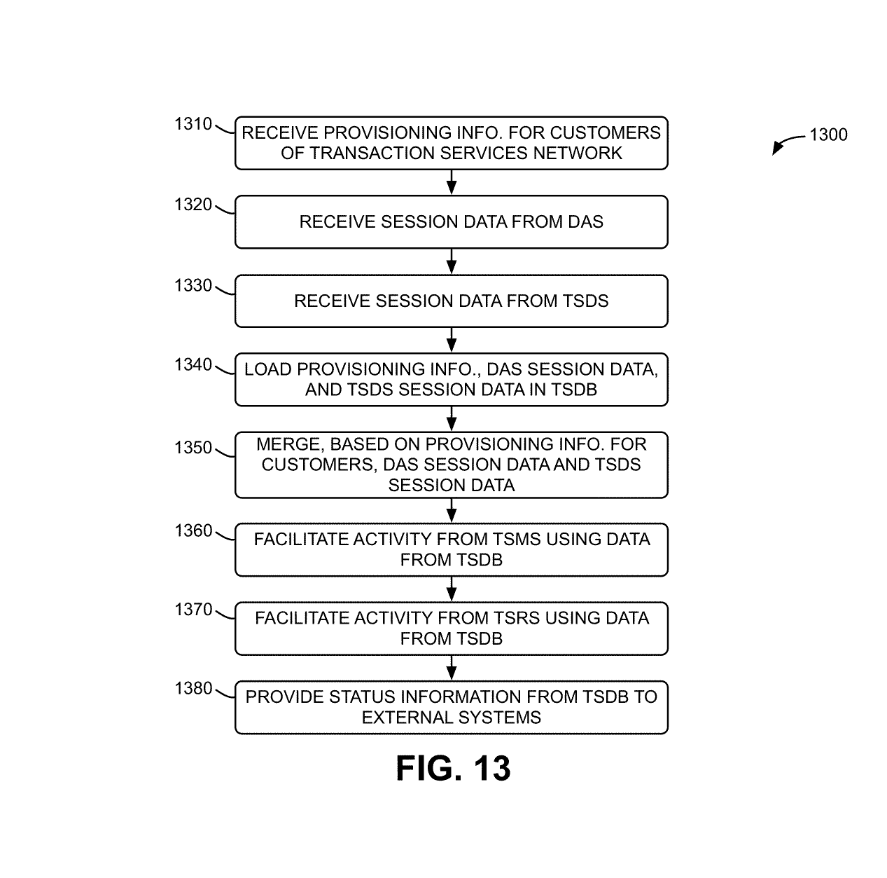

FIG. 13 is a flowchart of an exemplary process 1300 for providing tools for a transaction services network, according to an implementation described herein. In one implementation, process 1300 may be performed by one or more components of transaction services tools system 330, such as one or more processing units 520. In another implementation, one or more blocks of process 1300 may be performed by one or more other devices or a group of devices including or excluding transaction services tools system 330.

Process 1300 may include receiving provisioning information for customers of the transaction services network (block 1310). For example, as described in connection with FIG. 6, transaction services tools system 330 may receive, from network capacity server 270, routing files 660. Transaction services tools system 330 may also receive provisioning information 665 from provisioning status system 275.

Process 1300 may also include receiving session data from a dial access server (DAS) (block 1320), and receiving session data from a transaction services data system (TSDS) (block 1330). For example, as described above in connection with FIG. 6, transaction services tools system 330 may receive transaction files 610 from transaction services data system 300. Transaction files 610 may generally include information recorded from sessions between transaction devices 120 and payment processor 130. Transaction services tools system 330 may receive session data files 630 from dial access server(s) 215. Session data files 630 may include, for example, session detail records and/or accounting records for calls originating through voice network 205.

Process 1300 may further include loading the provisioning information, the dial access server session data, and the TSDS session data in a transaction services database (TSDB) (block 1340) and merging the collected session data based on the provisioning information for the customers (block 1350). For example, as described above in connection with FIG. 6, transaction services tools system 330 may validate, unpack, and load files into appropriate tables for transaction services database 340, as indicated by reference 670. Also, as described with respect to FIG. 10, transaction services tools system 330 may merge session detail records from dial access server 215 with session detail records (e.g., transaction files 610) produced by transaction gateway applications for transaction services data system 300.

Process 1300 may also include facilitating activity from a transaction services management system (TSMS) using data from the transaction services database (block 1360). For example, as described above in connection with FIG. 6, transaction services management system 310 may provide to transaction services tools system 330 instructions, such as provisioning instructions, configuration information, routing information, bandwidth reservations, port information, etc. that is required to support data transfers to/from a particular customer (e.g., payment processor 130). Transaction services management system 310 may also request information from transaction services tools system 330, such as reports or configuration information.

Process 1300 may include facilitating activity from a transaction services reporting system (TSRS) using data from the transaction services database (block 1370). For example, as described above in connection with FIG. 6, transaction services tools system 330 may receive certain requests from transaction services reporting system 320. The requests may correspond to, for example, a report request that includes a user's selection from a menu of available report types. In one implementation, requests may also include configuration changes, ad hoc reporting configurations, and/or point-of-contact changes for a particular customer.

Process 1300 may further include providing status information from the transaction services database to external systems (block 1380). For example, as described above in connection with FIG. 6, transaction services tools system 330 may monitor alarm tables and notify alarm server 255 of alarm conditions. Transaction services tools system 330 may also aggregate data from transaction files 610, session data files 630, and/or other data from transaction services database 340 and may provide the aggregated data to usage management server 260 as usage data 645.

Systems and/or methods described herein may provide transaction service tools within transaction services hub 230 to manage interfaces to supporting external systems, such as billing, provisioning, monitoring, customer notification, etc. The systems and/or methods may include a database and various tools to manage and maintain other components of transaction services hub 230, including a transaction services data system 300, a transaction services management system 310, and a transaction services reporting system 320.

In this specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While a series of blocks has been described with regard to the process 1300 illustrated in FIG. 13, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

1. A device within a transaction services hub that maintains secure sessions with multiple payment processor devices that are associated with customers of a transaction services network, comprising:
a memory to store a plurality of instructions; and
a processor configured to execute instructions in the memory to:
receive, from a first network device, provisioning information for customers of a transaction services network, wherein the provisioning information includes an indication that one of the payment processor devices is provisioned to begin receiving transaction requests from transaction devices, along with specific toll free numbers and routing plans for the customer,
receive, from a second network device, first session data provided by the one of the payment processor devices to first transaction devices, using an Internet Protocol (IP) network,
receive, from a third network device, second session data provided by the one of the payment processor devices to second transaction devices, using a voice network,
load, in a database, the provisioning information, the first session data, and the second session data, and
merge, based on the provisioning information, the first session data and the second session data.

2. The device of claim 1, wherein the processor is further configured to:
receive, from a customer interface system, a customer report request for a user account associated with a particular customer,
retrieve, from the database, data in response to the customer report request, and
provide, to the customer interface system, the data in response to the customer report request.

3. The device of claim 2, wherein, when retrieving data in response to the customer report request, the processor is further configured to:
access the database using calls to stored procedures.

4. The device of claim 1, wherein the processor is further configured to:
receive, from a management interface system, an administrator report request for non-session-specific data,
retrieve, from the database, data in response to the administrator report request, and
provide, to the management interface system, the data in response to the administrator report request.

5. The device of claim 1, wherein the processor is further configured to:
send, to a different network device and based on the first session data and the second session data, a usage indication of the transaction services by a particular customer.

6. The device of claim 1, wherein the processor is further configured to:
receive, from the second network device, an alarm indication in connection with the transaction services using the IP network or the transaction services using the voice network,
log, in the database, the alarm indication, and
send, to a different network device, a record of the alarm indication.

7. The device of claim 1, wherein, when loading the provisioning information, the first session data, and the second session data, the processor is further configured to:
place the provisioning information, the first session data, and the second session data into compressed archives, and
remove obsolete files from the database.

8. The device of claim 1, wherein the first session data includes:
usage detail records,
session detail records,
application status records, or
alarm detail records.

9. The device of claim 1, wherein the processor is further configured to:
receive, from the second network device, a health indication in connection with the transaction services using the IP network or the transaction services using the voice network, and
send, to a different network device and based on the health indication, a signal to initiate a repair ticket for the transaction services network.

10. The device of claim 1, wherein the transaction services include facilitating communication sessions between the customers and one of the payment processor devices, wherein the average session length is less than 15 seconds.

11. A method performed by one or more devices within a transaction services hub that maintains secure sessions with multiple payment processor devices that are associated with customers of a transaction services network, the method comprising:
receiving, by the one or more devices and from a first network device, provisioning information including an indication that one of the payment processor devices is provisioned to begin receiving transaction requests from transaction devices, along with specific toll free numbers and routing plans for the customer;
receiving, by the one or more devices and from a second network device, first session data, provided by the one of the payment processor devices to first transaction devices, using an Internet Protocol (IP) network;
receiving, by the one or more devices and from a third network device, second session data, provided by the one of the payment processor devices to second transaction devices, using a voice network;
loading, by the one or more devices and in a database, the provisioning information, the first session data, and the second session data;
receiving, by the one or more devices and from a management interface system, an administrator report request for non-session-specific data;
retrieving, by the one or more devices and from the database, data in response to the administrator report request; and
providing, by the one or more devices and to the management interface system, the data in response to the administrator report request.

12. The method of claim 11, further comprising:
merging, in the database and based on the provisioning information, the first session data and the second session data.

13. The method of claim 11, further comprising:
receiving, from a customer interface system, an administrator report request for a user account associated with a particular customer,
retrieving, from the database, data in response to the customer report request, and
providing, to the customer interface system, the data in response to the customer report request.

14. The method of claim 11, further comprising:
sending, to another network device and based on the first session data and the second session data, a usage indication of the transaction services by a particular customer.

15. The method of claim 11, further comprising:
receiving, from the second network device, an alarm indication in connection with the transaction services using the IP network or the transaction services using the voice network,
logging, in the database, the alarm indication, and
sending, to a different network device, a record of the alarm indication.

16. The method of claim 11, wherein retrieving data responsive to the administrator report request includes generating one or more calls to stored procedures within the database.

17. The method of claim 11, wherein loading the provisioning information, the first session data, and the second session data, further comprises:
placing the provisioning information, the first session data, and the second session data into compressed archives, and
removing obsolete files from the database.

18. A non-transitory computer-readable medium, comprising computer-executable instructions, for causing one or more processors executing the computer-executable instructions to:
receive, from a first network device, provisioning information for customers of a transaction services network, wherein the provisioning information includes an indication that payment processor devices, associated with the customers, are provisioned to begin receiving transaction requests from transaction devices, along with specific toll free numbers and routing plans for the customers;
receive, from a second network device, session data of the customers for transaction services, provided by the one of the payment processor devices to first transaction devices, using an Internet Protocol (IP) network or a voice network;
load, in a database, the configuration information and the session data;
receive, from a management interface system, an administrator report request for non-session-specific data;
retrieve, from the database, data responsive to the administrator report request; and
provide, to the management interface system, the data responsive to the administrator report request.

19. The computer readable medium of claim 18, further comprising computer-executable instructions, for causing one or more processors executing the computer-executable instructions to:
receive, from the second network device, a health indication in connection with the transaction services; and
send, to a different network device and based on the health indication, a signal to initiate a repair ticket for the transaction services network.

20. The computer readable medium of claim 18, further comprising computer-executable instructions, for causing one or more processors executing the computer-executable instructions to:
receive, from a customer interface system, an administrator report request for a user account associated with the particular customer;
retrieve, from the database, data in response to the customer report request; and
provide, to the customer interface system, the data in response to the customer report request.
